(19) United States
(12) Patent Application Publication
(10) Pub. No.: US 2022/0156608 A1
(43) Pub. Date: May 19, 2022

(54) INFERENCE DEVICE, INFERENCE METHOD, AND RECORDING MEDIUM

(71) Applicants: NEC CORPORATION, Tokyo (JP); NATIONAL INSTITUTE OF ADVANCED INDUSTRIAL SCIENCE AND TECHNOLOGY, Tokyo (JP)

(72) Inventors: Shumpei KUBOSAWA, Tokyo (JP); Takashi ONISHI, Tokyo (JP); Yoshimasa TSURUOKA, Tokyo (JP)

(73) Assignees: NEC CORPORATION, Tokyo (JP); NATIONAL INSTITUTE OF ADVANCED INDUSTRIAL SCIENCE AND TECHNOLOGY, Tokyo (JP)

(21) Appl. No.: 17/442,314

(22) PCT Filed: Mar. 23, 2020
(86) PCT No.: PCT/JP2020/012597

§ 371 Date: Sep. 23, 2021

(30) Foreign Application Priority Data
Mar. 28, 2019 (JP) 2019-064978

(51) Int. Cl. G06N 5/04; G06N 5/02

(52) U.S. Cl. CPC G06N 5/04; G06N 5/025

(57) ABSTRACT

An inference device makes an inference in accordance with first-order predicate logic by using: a true or false of a proposition that determines a state of a target by using a predicate that represents the state of the target; and an inference rule where a predicate representing a state of a target in an antecedent differs from a predicate representing a state of a target in a consequent. The predicate representing the state of the target in the antecedent and the predicate representing the state of the target in the consequent represent a proposition that determines a state of a target in a different time step.

### TECHNICAL FIELD

The present invention relates to an inference device, an inference method, and a recording medium.

### BACKGROUND ART

In a qualitative inference, inference rules can be expanded to handle temporal changes.

For example, in the qualitative inference system described in Patent Document 1, a function that refers to a physical quantity at a previous time is introduced in an antecedent or consequent of a rule. When the function is used by the qualitative inference system, a dictionary from before the current time is fetched from a history pool, and the corresponding value of the physical quantity is fetched.

### PRIOR ART DOCUMENTS

### [Patent Document]

[Patent Document 1] Japanese Unexamined Patent Application, First Publication No. H6-187153

### SUMMARY OF THE INVENTION

### Problem to be Solved by the Invention

If temporal changes can be handled in a qualitative inference without the need to extend the inference rules, the burden of modifying the inference device can be suppressed.

An example object of the present invention is to provide an inference device, an inference method, and a recording medium that are capable of solving the above problem.

### Means for Solving the Problem

According to a first example aspect of the present invention, an inference device includes: an inference means for making an inference in accordance with first-order predicate logic by using: a true or false of a proposition that determines a state of a target by using a predicate that represents the state of the target; and an inference rule where a predicate representing a state of a target in an antecedent differs from a predicate representing a state of a target in a consequent, the predicate representing the state of the target in the antecedent and the predicate representing the state of the target in the consequent represent a proposition that determines a state of a target in a different time step.

According to a second example aspect of the present invention, an inference method is executed by a computer, and includes: making an inference in accordance with first-order predicate logic by using: a true or false of a proposition that determines a state of a target by using a predicate that represents the state of the target; and an inference rule where a predicate representing a state of a target in an antecedent differs from a predicate representing a state of a target in a consequent, the predicate representing the state of the target in the antecedent and the predicate representing the state of the target in the consequent represent a proposition that determines a state of a target in a different time step.

According to a third example aspect of the present invention, a recording medium stores a program for causing a computer to execute: making an inference in accordance with first-order predicate logic by using: a true or false of a proposition that determines a state of a target by using a predicate that represents the state of the target; and an inference rule where a predicate representing a state of a target in an antecedent differs from a predicate representing a state of a target in a consequent, the predicate representing the state of the target in the antecedent and the predicate representing the state of the target in the consequent represent a proposition that determines a state of a target in a different time step.

### Effect of the Invention

According to an example embodiment of the present invention, an inference device that makes a qualitative inference can handle temporal changes.

### BRIEF DESCRIPTION OF THE DRAWINGS

FIG. 1 is a schematic block diagram showing a functional configuration of an inference device according to an example embodiment.

FIG. 2 is a diagram showing an example of state information before execution of a qualitative inference by the inference device according to the example embodiment.

FIG. 3 is a diagram showing an example of an inference result of the opening degree of flow rate adjustment valves obtained by an inference unit according to the example embodiment.

FIG. 4 is a diagram showing an example of an inference result of the states of targets in the next time step according to the example embodiment.

FIG. 5 is a diagram showing an example of the states of targets when a time step updating unit according to the example embodiment updates the time step.

FIG. 6 is a diagram showing a schematic example of the structure of a distillation tower, which represents an inference target of the inference device according to the example embodiment.

FIG. 7 is a diagram showing an example of the configuration of the inference device according to the example embodiment.

FIG. 8 is a diagram showing an example of the processing procedure of an inference method according to the example embodiment.

FIG. 9 is a schematic block diagram showing a configuration of a computer according to at least one example embodiment.

### EXAMPLE EMBODIMENT

Hereunder, example embodiments of the present invention will be described. However, the following example embodiments do not limit the invention according to the claims. Furthermore, not all combinations of features described in the example embodiment is essential to the solution means of the invention.

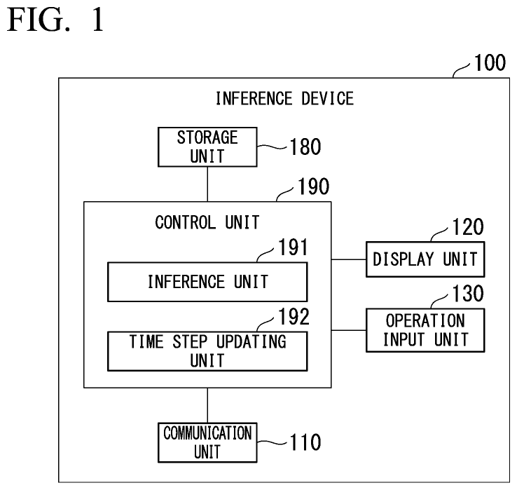

FIG. 1 is a schematic block diagram showing a functional configuration of an inference device 100 according to example embodiment. In the configuration shown in FIG. 1, the inference device 100 includes a communication unit 110, a display unit 120, an operation input unit 130, a storage unit 180, and a control unit 190. The control unit 190 includes an inference unit 191 and a time step updating unit 192.

The inference device 100 is an inference device capable of handling temporal changes. Specifically, the inference device 100 makes a qualitative inference that handles temporal changes within the framework of first-order predicate logic.

Consequently, the inference device 100 uses state information which represents the state of a target handled in a qualitative inference (hereunder, also simply referred to as the target) by the true/false of a proposition. Specifically, the inference device 100 is provided with a predicate that indicates, with respect to the same target for each time step and each possible state of the target, whether the state of the target is that state. Then, for at least one time step, the true/false of a proposition using the predicate indicates which one of the plurality of states the state of the object is. Specifically, when the state of the target in that time step matches the state represented by the predicate, the value of the proposition using the predicate is set to true. On the other hand, when the state of the target in that time step does not match the state represented by the predicate, the value of the proposition using the predicate is set to false.

Here, the time width for discretely sampling the time of the target subjected to the qualitative inference is referred to as a time step. Furthermore, the individual times at which sampling is performed in each of the time steps are also referred to as time steps.

The target of the inference by the inference device 100 may be, for example, a chemical plant that manufactures a synthetic product from a plurality of raw materials. For example, in a chemical plant, which is the target, a synthetic product is produced from a plurality of raw materials via a plurality of intermediates. In such a chemical plant, synthetic products or intermediates are produced through multiple processes, from an input to each process. In such a chemical plant, an adjustment valve for adjusting the input amount to the process, and piping and the like through which the raw materials and intermediates flow, are installed with respect to each process.

In the present example embodiment, for convenience of description, it is assumed that the target is a chemical plant. Furthermore, it is assumed that, in order to manufacture a desired synthetic product, the degree by which each flow rate adjustment valve installed in the chemical plant is opened or closed (opening degree) is controlled. In this case, the inference device 100 may control, for example, the degree (state) by which each flow rate adjustment valve is opened or closed when manufacturing the desired synthetic product. The target of the inference by the inference device 100 is not limited to a chemical plant, and may be any target that includes a process in which an output amount is determined according to an input amount. The control target may be, for example, a factory that produces electrical products, a factory that produces processed agricultural products, and the like.

In the above example, the qualitative states related to an increase or decrease in the flow rate of a fluid flowing through a flow path inside a piping are, for example, the three states of increase, decrease, or no change (no increase or decrease). The predicates (labels) indicating the three states are represented by “+”, “−”, and “0”, respectively.

Furthermore, the current time step is assumed to be indicated by “now”. The next time step is assumed to be indicated by “next”. A predicate is written by combining a label of the time step and a label of the state, such as in “now+”. When the flow path in a piping is represented by A, the proposition that the flow rate of the fluid in the flow path A is increasing in the current time step is represented by “now+(A)”. The value of the proposition (true/false) can indicate whether or not the flow rate of the fluid in the flow path A is increasing.

The inference device 100 makes a qualitative inference by applying the state information indicated by a proposition as described above to an inference rule. Examples of the processing performed by the inference device 100 in a qualitative inference include the following three processes: (i) inference of a state within the same time step; (ii) inference of a state in another time step; and (iii) updating of the time step.

(i) In an inference of a state within the same time step, the inference device 100 performs one or both of a deduction, which derives a conclusion from the assumptions (preconditions) of an inference rule, and an abduction, which infers the assumptions from a conclusion. For both deductions and abductions, common inference methods that do not handle temporal changes can be used.

(ii) In an inference of a state in another time step, the inference device 100 similarly performs one or both of a deduction and an abduction. For example, given the variables x and y, where x is located upstream of y in the flow path (which corresponds to “up (x, y)”), if the flow rate at x is increasing in the current time step, then an inference rule indicating that the flow rate at y increases in the next time step can be written “up (x, y)\hat{ }now+(x)=>next+(y)”.

The symbol “\hat{ }” represents the logical product. The symbol “=>” represents “then”. That is to say, “=>” indicates that the consequent (on the right side of “=>”) can be derived from the antecedent (on the left side of “=>”). “x” and “y” represent variables. Information representing a specific location (such as position A, position B, and the like) can be input to “x” and “y”.

Here, it is assumed that “up (A, B)” is true. That is to say, position A in the flow path is actually located on the upstream side of position B. Furthermore, it is assumed that “now+(A)” is true. That is to say, the flow rate at position A is actually increasing in the current time step. In this case, the inference device 100 respectively inputs A and B into the variables x and y in the inference rule “up (x, y)\hat{ }now+(x)=>next+(y)”. As a result, the proposition “next+(B)” (whether or not the flow rate in B will increase in the next time step) can be deductively inferred.

In particular, the inference device 100 is capable of acquiring the information “next+(B)” relating to the state in the next time step based on the information “now+(A)” relating to the state in the current time step. Therefore, based on the state in a certain time step, the inference device 100 can infer the state in the next state step.

As the deduction method in this case, the inference device 100 can use the same deduction methods as those used in a common qualitative inference that does not handle temporal changes, in which a proposition is applied to an inference rule. Even when the inference device 100 uses the state information in a certain time step to obtain the state in another time step by abduction, it is possible to use the same abduction methods as those used in a common qualitative inference that does not handle temporal changes, in which a proposition is applied to an inference rule.

As described above, in the inference device 100, the state information in each of the plurality of time steps is shown in the form of propositions in first-order predicate logic. As a result, in the inference device 100, (i) inference of a state within the same time step, and (ii) inference of a state in another time step can be applied without extending the inference method in terms of common predicate logic. In particular, in the inference device 100, it is not necessary to provide a mechanism to manage state information beyond the framework of first-order predicate logic, such as grouping and storing the state of the target in each time step.

(iii) In updating the time step, the inference device 100 uses the value (true/false) of a proposition representing the state information in a certain time step to overwrite the value of a proposition representing the same state of the same target in the previous time step. That is to say, the inference device 100 updates the value (true/false) of the proposition in the previous time step with the value (true/false) of the proposition in the next time step. Then, the inference device 100 resets the value of the proposition representing the source of the overwrite (sets it to a value indicating an undetermined (uninferred) state).

For example, when the proposition “now+(A)” is false and the proposition “next+(A)” is true, the inference device 100 replaces the value of the proposition “now+(A)” to true so as to match the value of the proposition “next+(A)”. Then, the inference device 100 resets the value of the proposition “next+(A)”, which represents the source of the rewrite.

As a result, the inference device 100 updates the time step so that the time step being referred to as the next time step (next) is referred to as the current time step (now).

As described above, in (iii) updating of the time step, the inference device 100 performs processing which overwrites the value of a proposition, which is an extension of the framework of first-order predicate logic. However, the inference device 100 can update the time step by the relatively simple processing of overwriting and resetting the values of the propositions.

The communication unit 110 performs communication with other devices. For example, the communication unit 110 acquires information used in a qualitative inference, such as information relating to inference rules and state information of the inference target, from other devices.

The display unit 120 includes, for example, a display screen such as a liquid crystal panel or an LED (Light Emitting Diode) panel, and displays various images. For example, the display unit 120 displays the inference result obtained by the inference device 100.

The operation input unit 130 includes input devices such as a keyboard and a mouse, and accepts user operations. For example, when the user inputs information used in a qualitative inference, the operation input unit 130 accepts the input.

The storage unit 180 stores various information. The storage unit 180 is configured by using a storage device included in the inference device 100.

The control unit 190 executes various processing by controlling each unit of the inference device 100. The functions of the control unit 190 are executed as a result of a CPU (Central Processing Unit) included in the inference device 100 reading and executing a program from the storage unit 180.

The inference unit 191 executes a qualitative inference. In particular, the inference unit 191 performs the processing of (i) inference of a state within the same time step and (ii) inference of a state in another time step described above.

As described above, in the inference device 100, the state of the target is represented by the true/false of a proposition. Specifically, the inference device 100 uses state information that indicates, by the true/false of a proposition using a predicate provided with respect to the same target for each time step and for each possible state of the target, which of the plurality of states the target has been in for at least one time step. In (ii) inference of a state in another time step, the inference unit 191 makes a qualitative inference by first-order predicate logic using the state information and an inference rule representing an inference between a plurality of time steps using the predicate described above.

The time step updating unit 192 performs (iii) updating of the time step described above. In (iii) updating of the time step, as described above, the time step updating unit 192 performs processing that uses the value of a proposition representing the state information in a certain time step to overwrite the value of a proposition of the same state of the same target in the previous time step, and processing that resets the value of the proposition representing the source of the overwrite.

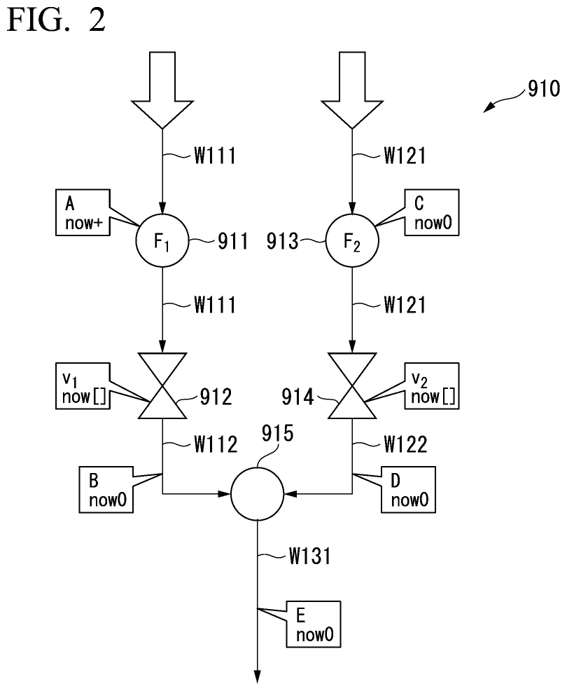

Next, the processing performed by the inference device 100 will be further described using an example with reference to FIG. 2 to FIG. 5.

FIG. 2 is a diagram showing an example of state information before execution of a qualitative inference by the inference device 100. FIG. 2 to FIG. 5 show an example in which the inference device 100 infers an increase or decrease in the flow rate of a fluid in a piping provided with flow rate adjustment valves.

In the piping 910 shown in FIG. 2 to FIG. 5, a fluid flowing through the flow path W111 of the piping flows into the flow rate adjustment valve 912. The fluid flowing through the flow rate adjustment valve 912 flows through the flow path W112. A flow meter 911 is provided in the flow path W111. Furthermore, a fluid flowing through the flow path W121 flows into the flow rate adjustment valve 914. After passing through the flow rate adjustment valve 914, the fluid flows through the flow path W122. A flow meter 913 is provided in the flow path W121.

The fluid flowing through the flow path W112 and the fluid flowing through the flow path W122 merge at a joined position 915 of the piping, and the merged fluid flows through the flow path W131.

The flow paths W111, W112, W121, W122, and W131 are referred to as “A”, “B”, “C”, “D”, and “E”, respectively. Moreover, the flow meters 911 and 913 are referred to as “F₁” and “F₂”, respectively. The flow rate adjustment valves 912 and 914 are referred to as “v₁” and “v₂”, respectively.

The inference device 100 does not make a quantitative inference with respect to the magnitude of the flow rate, but makes a qualitative inference as to whether an increase, a decrease, or no change (no increase or decrease) occurs in the flow rate. In the example of FIG. 2 to FIG. 5, an increase, a decrease, and no change in the flow rate are indicated by “+”, “−”, and “0”, respectively. Similarly, an increase, a decrease, and no change in the opening degree of a flow rate adjustment valve is also indicated by “+”, “−”, and “0”, respectively.

“Now” in the example of FIG. 2 represents the current time step (reference time step). Furthermore, in the example of FIG. 2, an increase or decrease in the flow rate in the current time step is determined using predicates that combine “now” with “+”, “−”, or “0”, namely “now +”, “now −”, and “now 0”. Similarly, an increase or decrease in the opening degree of the flow rate adjustment valve in the current time step is determined using the predicates “now +”, “now −”, and “now 0”.

In the example of FIG. 2, the increase or decrease in the flow rate of the fluid in the flow paths W111, W112, W121, W122, and W131 is assumed to actually be “+”, “0”, “0”, “0”, and “0”, respectively. In the example of FIG. 2, an increase or decrease in the fluid is determined by the true/false of a proposition. For example, a state in which the flow rate in the flow path W111 is increasing is determined by the proposition “now+(A)” being true, that is to say, “now+(A)=true”. “true” indicates true.

On the other hand, the fluid in the flow path W111 is “+” in the time step “now”. Therefore, “now−(A)=false”, and “now 0 (A)=false”. “false” indicates false.

On the other hand, in the example of FIG. 2, the opening degree of the flow rate adjustment valves 912 and 914 does not indicate an increase or decrease. Therefore, the inference unit 191 infers the opening degree of each of the flow rate adjustment valves 912 and 914. The inference unit 191 infers the opening degree of each of the flow rate adjustment valves 912 and 914 by a common qualitative inference using first-order predicate logic which does not handle temporal changes.

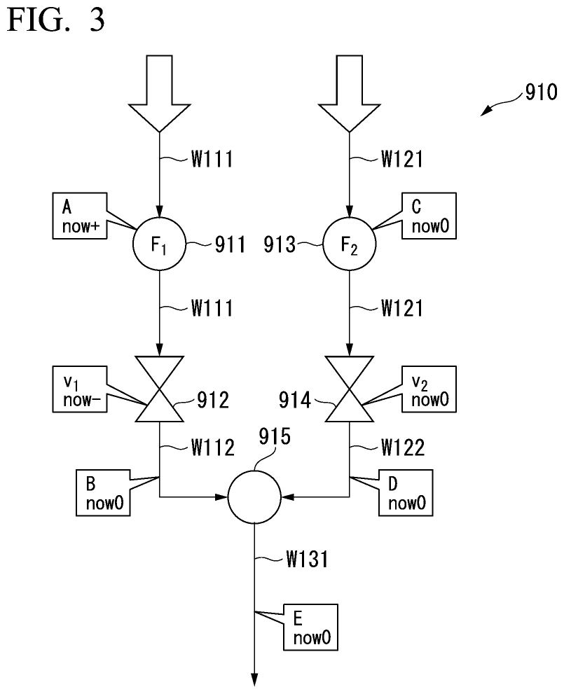

FIG. 3 is a diagram showing an example of an inference result obtained by the inference unit 191 for the opening degree of the flow rate adjustment valves. The example of FIG. 3 is different from FIG. 2 in that the increase or decrease in the opening degree of each of the flow rate adjustment valves 912 and 914 is shown. The example of FIG. 3 is the same as the case of FIG. 2 except for the above (for example, the increase or decrease in the flow rate in the piping).

The processing that obtains the opening degree of each of the flow rate adjustment valves 912 and 914 shown in FIG. 3 by using the information shown in FIG. 2 corresponds to an example of (i) inference of a state within the same time step described above. In the example of FIG. 2, the inflow amount to the flow rate adjustment valve 912 is increasing (the flow rate of the fluid in the flow path W111 is increasing (+)), while the outflow amount from the flow rate adjustment valve 912 is not increasing or decreasing (no change in the flow rate of the fluid in the flow path W112).

Therefore, the inference unit 191 infers that the opening degree of the flow rate adjustment valve 912 is decreasing. The inference unit 191 represents this by inferring that the value of the proposition “now−(v₁)” is true, that is to say, “now−(v₁)=true”. Like the case of the flow rate of the fluid, only one of an increase, decrease, or no change holds for the opening degree of a flow rate adjustment valve. Therefore, when the opening degree of the flow rate adjustment valve 912 is decreasing, “now+(v₁)=false” and “now 0 (v₁)=false”.

The inference rule in this case is represented within the framework of first-order predicate logic, such as “now+(A)\hat{ }now 0 (B)=>now−(v₁)”. When the relationship between the opening degree of the flow rate adjustment valve z, the inflow amount x into the flow rate adjustment valve z, and the outflow amount y from the flow rate adjustment valve z is expressed using a logical expression, and the terms A, B, and v₁ in the inference rule above is replaced by the variables x, y, and z, the inference rule in this case is represented within the framework of first-order predicate logic as “now+(x)\hat{ }now 0 (y)=>now−(z)”.

In terms of the flow rate adjustment valve 914, there is no change in the flow rate of either the inflow amount or the outflow amount in the time step “now”. From this, the inference unit 191 infers that there is no change in the opening degree of the flow rate adjustment valve 914. The inference unit 191 represents this as “now 0 (v₂)=true”. In this case, “now+(v₂)=false” and “now−(v₂)=false”.

Like the case of the flow rate adjustment valve 912, the inference rule in this case is represented within the framework of first-order predicate logic as “now 0 (C)\hat{ }now 0 (D)=>now−(v₂)”.

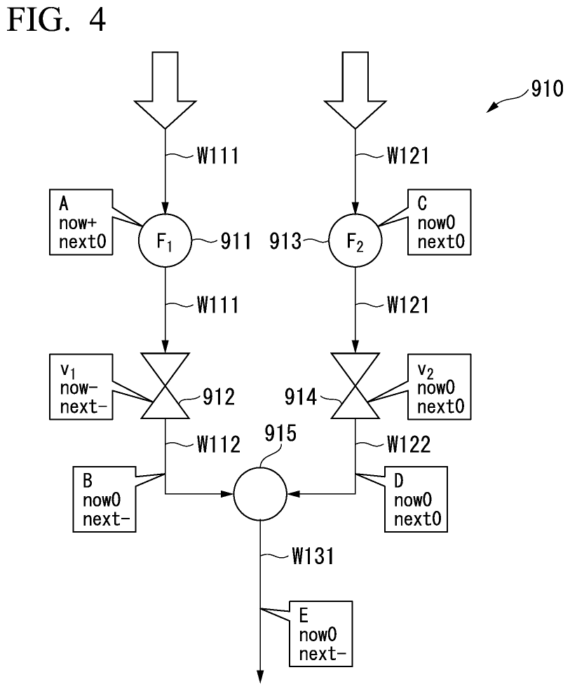

FIG. 4 is a diagram showing an example of an inference result of the states of the targets in the next time step. The inference unit 191 infers the state of the targets shown in FIG. 4 based on the information shown in FIG. 3. This inference corresponds to an example of (ii) inference of a state in another time step described above.

In the example of FIG. 3, the time step following the current time step (now) is represented by “next”. Like the case of the current time step, an increase or decrease in the flow rate is represented by the true/false of a logical expression using predicates that combine “next” with the increase or decrease in the flow rate of the fluid “+”, “−”, or “0”, namely “next +”, “next −”, and “next 0”. Similarly, with respect to the increase or decrease in the opening degree of the flow rate adjustment valve, the increase or decrease in the flow rate is represented by the true/false of a logical expression using the predicates “next +”, “next −”, and “next 0”.

For example, the inference unit 191 assumes that the increase or decrease in the opening degree of the flow rate adjustment valve in the next time step is the same as in the case of the current time step, and infers that the increase or decrease in the opening degree of the flow rate adjustment valve 912 will decrease as in the case of the current time step.

The inference rule in this case is represented by equation (1).

[Equation 1]

valve(x)∧now−(x)⇒next−(x) (1)

The proposition “valve (x)” is true when the variable x represents a flow rate adjustment valve.

The inference rule represented by equation (1) expresses an inference rule that indicates that, when the variable x represents a flow rate adjustment valve, and the inflow amount into x in the time step “now” is decreasing, the outflow amount from x in the next time step “next” will decrease. Even when the variable x represents a flow rate adjustment valve, if the inflow amount into x in the time step “now” indicates no change or an increase, the proposition “now−(x)” is false. Consequently, the proposition “next−(x)” is false. That is to say, this indicates that the outflow amount from x in the next time step “next” will not decrease.

Equation (1) differs from a common qualitative inference using first-order predicate logic in that the concept of time steps has been introduced. However, an inference can be carried out within the framework of first-order predicate logic in that the conclusion holds when the preconditions (assumptions) hold. For this reason, a common inference engine for a qualitative inference that handles first-order predicate logic can be used as the inference engine.

An inference rule like equation (1) that infers the state of a target in another time step based on the state of the object in a certain time step (an inference rule in (ii) above) is referred to as a now-next inference rule. An inference using a now-next inference rule (an inference of (ii) above) is referred to as a now-next inference.

Furthermore, because the increase or decrease in the flow rate of the fluid in the flow path W111 in the current time step indicates an increase (now+(A) is true), and the opening degree of the flow rate adjustment valve 912 in the current time step indicates a decrease (now−(v1) is true), the inference unit 191 infers that there will be no change in the flow rate of the fluid in the flow path W111 in the next time step (next 0 (A) is true). The inference rule in this case is represented by equation (2).

[Equation 2]

valve in(x)∧now+(x)∧valve(y)∧now−(y)⇒next0(x) (2)

The proposition “valve in (x)” is true when x is located on the inflow side of a flow rate adjustment valve. Equation (2) also corresponds to an example of a now-next inference rule. It is also possible to use an inference engine for a common qualitative inference using first-order predicate logic with respect to equation (2).

Moreover, because the increase or decrease in the flow rate of the fluid in the flow path W112 in the current time step “now” indicates no change (now 0 (B) is true), and the current opening degree of the flow rate adjustment valve 912 indicates a decrease (now−(v1) is true), the inference unit 191 infers that there will be a decrease in the flow rate of the fluid in the flow path W112 in the next time step (next−(B) is true).

The inference rule in this case is represented by equation (3).

[Equation 3]

valve out(x)∧now0(x)∧valve(y)∧now−(y)⇒next−(x) (3)

The predicate “valve out (x)” is true when x is located on the outflow side of the valve. Equation (3) also corresponds to an example of a now-next inference rule. It is also possible to use an inference engine for a common qualitative inference using first-order predicate logic with respect to equation (3).

The inference unit 191 infers the increase or decrease in the opening degree of the flow rate adjustment valve 914, and the increase or decrease in the flow rate of the fluid in each of the flow paths W121, W122, and S131 using a now-next inference. It is also possible to use an inference engine for a common qualitative inference using first-order predicate logic with respect to these inference rules.

In an inference rule, as shown for “bin(x, y, z)” in equation (4), a binary operation can be represented using the predicates of the arguments (x, y) and the output (the value (z) of the binary operation) of the binary operation.

[Equation 4]

bin(x,y,z)∧next−(x)∧next0(y)⇒next−(z) (4)

Equation (4) represents an inference rule in which “if x, y, and z have the relationship of bin, and x will decrease in the next time step “next”, and there will be no change in y in the next time step, then z will decrease in the next time step”. “bin(x, y, z)” represents a logical expression of the calculation “z=bin(x, y)” using the binary operator bin, and is defined as a predicate as follows.

$${bin ( x , y , z )}^{⩓} 0 {( x )}^{⩓} 0 ( y ) \text{=>} 0 ( z ) , \\ {bin ( x , y , z )}^{⩓} 0 {( x )}^{⩓} + ( y ) \text{=>} + ( z ) , \\ …$$

$$“ {bin ( x , y , z )}^{⩓} 0 {( x )}^{⩓} 0 ( y ) \text{=>} 0 ( z ) ” represents “ bin ( 0 , 0 ) = 0 ” . “ {bin ( x , y , z )}^{⩓} 0 {( x )}^{⩓} \\ + ( y ) \text{=>} + ( z ) ” represents “ bin ( 0 , + ) = + ” .$$

Because the return value (evaluation value) of a predicate in predicate logic is a true/false value, a definition such as “z=bin(x, y)” is not possible. Therefore, the return value (value of the binary operation) z of the binary operation is added as an argument of the predicate, so that the predicate is written as “bin(x, y, z)”. A binary operation can be expressed by reading this as “z=bin(x, y)”.

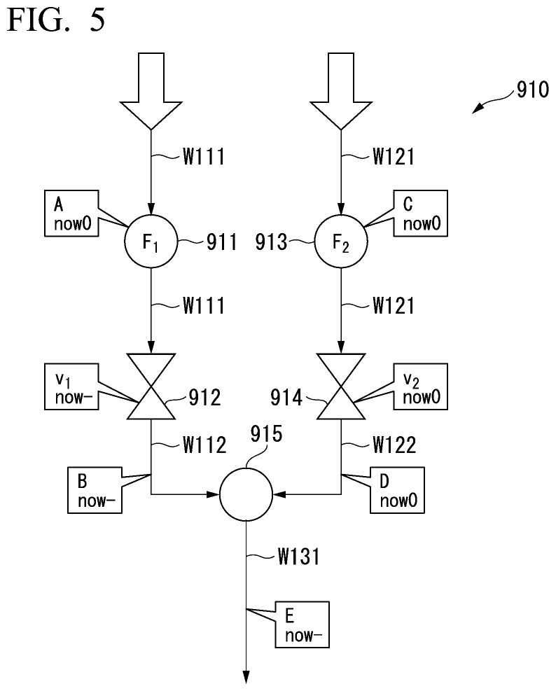

FIG. 5 is a diagram showing an example of the states of the targets when the time step updating unit 192 updates the time step. FIG. 5 shows an example in which the time step updating unit 192 updates the next time step in the state shown in FIG. 4 to be the current time step. The update processing from the example of FIG. 4 to the example of FIG. 5 corresponds to an example of (iii) updating of the time step described above.

The time step updating unit 192 advances the time step by one step by rewriting the state such that the state of the next time step becomes the state of the current time step. In other words, the time step updating unit 192 overwrites (updates) the values of the propositions in the current time step with the values of the propositions in the next time step.

For example, with respect to the flow rate of the fluid in the flow path W111, as shown in FIG. 5, the time step updating unit 192 sets “now 0” (that is to say, sets the proposition “now 0 (A)” to true) based on “next 0” in FIG. 4 (that is to say, the proposition “next 0 (A)” is true).

Furthermore, the time step updating unit 192 resets (to unestimated) the value of the proposition in the next time step. For example, the true/false of the proposition “next 0 (A)” in the example of FIG. 5 is unknown (unestimated), and is not shown in FIG. 5.

Comparing FIG. 4 and FIG. 5, in FIG. 4 the proposition “now+(A)” is true, and therefore the proposition “now 0 (A)” is false, while in FIG. 5 the proposition “now 0 (A)” is true. In this way, in the respect that the true/false of the same proposition differs depending on the time step, it can be said that the time step update processing performed by the time step updating unit 192 is an extension of first-order predicate logic.

On the other hand, like the case of the example of FIG. 3 and FIG. 4, the inference unit 191 can make an inference within the framework of first-order predicate logic after the time step updating unit 192 has updated the time step. In this way, the time step updating unit 192 can advance the time step to the next time step by simple processing that rewrites the values of the propositions in the current time step with the values of the propositions in the next time step, and resets the values of the propositions in the next time step.

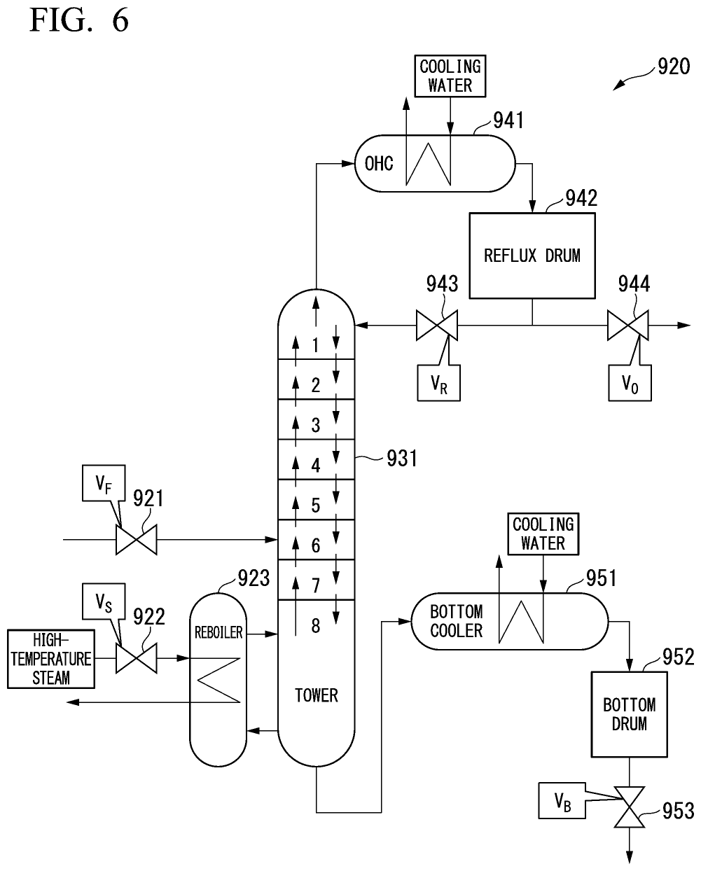

Next, the processing performed by the inference device 100 will be further described using an example with reference to FIG. 6.

FIG. 6 is a diagram showing a schematic example of the structure of a distillation tower 931, which represents an inference target of the inference device 100. In the distillation system 920 shown in FIG. 6, the distillation tower 931 is configured as an eight-stage tower. The liquid to be distilled (hereunder referred to as the distillation target) flows into the distillation tower 931 after the flow rate is adjusted by a flow rate adjustment valve 921. A reboiler 923 is connected to the distillation tower 931. In the reboiler 923, high-temperature steam circulates whose flow rate is regulated by a flow rate adjustment valve 922. The reboiler 923 uses the heat of the high-temperature steam to heat and distill the distillation target.

The product distilled in the distillation tower 931 (hereunder referred to as the distillation product) flows into an overhead condenser (OHC) 941 in a gaseous state. Cooling water circulates in the overhead condenser 941. The overhead condenser 941 uses the cooling water to cool and liquefy the distillation product. The distillation product liquefied by the overhead condenser 941 flows into a reflux drum 942. The reflux drum 942 is provided with a path for returning the distillation product to the distillation tower 931 via a flow rate adjustment valve 943, and a path for the distillation product to be output to the outside of the distillation system 920 via a flow rate adjustment valve 944.

Furthermore, a bottom cooler 951 is connected to the distillation tower 931. Cooling water circulates in the bottom cooler 951. The bottom cooler 951 cools the distillation target flowing in from the distillation tower 931 with cooling water and outputs it to a bottom drum 952. The distillation target which has flowed into the bottom drum 952 from the bottom cooler 951 is accumulated in the bottom drum 952, and then output to the outside of the distillation system 920 via a flow rate adjustment valve 953.

The flow rate adjustment valves 921, 922, 943, 944 and 953 are represented by V_{F}, V_{S}, V_{R}, V_{O}, and V_{B}, respectively.

Moreover, in the following, the flow rates before and after the flow rate adjustment valves are indicated by F* (where * indicates any of F, S, R, O, and B to distinguish the flow rate adjustment valves).

When the distillation system 920 is started, the state of each unit of the distillation system 920 can be represented as follows.

### (1. Initial State)

In the initial state of the distillation system 920, the state of each unit of the distillation system 920 is represented by “unchange” or “invalid”. “unchange” indicates that there is no state change. “invalid” indicates an invalid state, that is to say, a state where the target is not functioning.

### (2. Propositions to Determine States Related to Distillation Tower 931)

### (2.1. Proposition to Determine Tower Feedable State)

The tower feedable state is a state in which the distillation tower 931 is capable of executing distillation.

The flow rate adjustment valve 921 is open (not fully closed) in the tower feedable state. The proposition to determine this state is represented by valid (V_{F}). “valid” indicates a valid state, that is to say, a state where the target is functioning. In the case of a valve, “valid” indicates that the valve is not fully closed.

### (2.2. Proposition to Determine Tower Feed Increasing State)

The tower feed increasing state is a state in which the amount of the distillation target supplied to the distillation tower 931 is being adjusted, and the amount of the distillation target increases.

In the tower feed increasing state, the opening degree of the flow rate adjustment valve 921 increases, and the flow rate of the distillation target in the flow rate adjustment valve 921 increases. The propositions to determine this state are represented by valid (V_{F}), increase (V_{F}), and increase (F_{F}). An “increase” in terms of a flow rate adjustment valve indicates an increase in the opening degree of the flow rate adjustment valve. An “increase” in terms of a flow rate indicates an increase in the flow rate.

### (2.3. Proposition to Determine Tower Feed Constant State)

The tower feed constant state is a state in which the amount of the distillation target supplied to the distillation tower 931 is constant.

The propositions to determine the tower feed constant state are represented by valid (V_{F}), unchange (V_{F}), and unchange (F_{F}).

### (2.4. Proposition to Determine Tower Feed Decreasing State)

The tower feed decreasing state is a state in which the amount of the distillation target supplied to the distillation tower 931 is being adjusted, and the amount of the distillation target decreases.

The propositions to determine the constant tower feed state are represented by valid (V_{F}), decrease (V_{F}), and decrease (F_{F}). A “decrease” in terms of a flow rate adjustment valve indicates a decrease in the opening degree of the flow rate adjustment valve. A “decrease” in terms of a flow rate indicates a decrease in the flow rate.

### (2.5. Proposition to Determine Tower Feed Stopped State)

The tower feed stopped state is a state in which the distillation tower 931 has stopped distillation.

The propositions to determine the tower feed stopped state are represented by invalid (V_{F}) and unchange (F_{F}).

### (3. States Related to Reboiler 923)

### (3.1. Proposition to Determine Reboiler Operation State)

The reboiler operatable state is a state in which the reboiler 923 can be operated.

The proposition to determine the reboiler operatable state is represented by valid (V_{S}).

### (3.2. Proposition to Determine Reboiler Steam Increasing State)

The reboiler steam increasing state is a state in which the flow rate of the high-temperature steam supplied to the reboiler 923 is increasing.

The propositions to determine the reboiler steam increasing state are represented by valid (V_{S}) and increase (F_{S}).

### (3.3. Proposition to Determine Reboiler Steam Constant State)

The reboiler steam constant state is a state in which the flow rate of the high-temperature steam supplied to the reboiler 923 is constant.

The propositions to determine the reboiler steam constant state are represented by valid (V_{S}) and unchange (F_{S}).

### (4. Propositions to Determine States Related to Total Reflux Operation)

The total reflux operation related state is a state in which the supply of the distillation product from the distillation system 920 to the outside is stopped. In the total reflux operation related state, all of the distillation product produced by the distillation tower 931 is refluxed (returned) to the distillation tower 931.

The proposition to determine the total reflux operation related state is represented by invalid (V_{O}).

### (4.1. Proposition to Determine Reflux Implemented State)

The reflux implemented state is a state in which at least some of the distillation product produced by the distillation tower 931 is refluxed to the distillation tower 931.

The proposition to determine the reflux implemented state is represented by valid (V_{R}).

### (4.2. Proposition to Determine Reflux Increasing State)

The reflux increasing state is a state in which the flow rate of the distillation product which is refluxed from the reflux drum 942 to the distillation tower 931 is increasing.

The propositions to determine the reflux increasing state are represented by valid (V_{R}), increase (V_{R}), and increase (F_{R}).

### (4.3. Proposition to Determine Reflux Constant State)

The reflux constant state is a state in which the flow rate of the distillation product which is refluxed from the reflux drum 942 to the distillation tower 931 is constant.

The propositions to determine the reflux constant state are represented by valid (V_{R}), unchange (V_{R}), and unchange (F_{R}).

### (5. States Related to Product Extraction)

### (5.1. Proposition to Determine Extraction Implemented State)

The extraction implemented state is a state in which the distillation product produced by the distillation tower 931 is supplied to the outside of the distillation system 920.

The proposition to determine the extraction implemented state is represented by valid (V_{O}).

### (5.2. Proposition to Determine Extraction Increasing State)

The extraction increasing state is a state in which the amount of the distillation product produced by the distillation tower 931 and supplied to the outside of the distillation system 920 is increasing.

The proposition to determine the extraction increasing state is represented by valid (V_{O}), increase (V_{O}), and increase (F_{O}).

### (5.3. Proposition to Determine Extraction Constant State)

The extraction constant state is a state in which the amount of the distillation product produced by the distillation tower 931 being supplied to the outside of the distillation system 920 is constant.

The proposition to determine the extraction constant state is represented by valid (V_{O}), unchange (V_{O}), and unchange (F_{O}).

### (6. Proposition to Determine Steady State)

In the steady state of the distillation system 920, the proposition to determine the state of each unit of the distillation system 920 is represented by “unchange” or “valid”.

The inference device 100 can simulate the operation (state transitions) of the distillation system 920 by using inference rules relating to the states of the distillation system 920. Specifically, a transition between the states mentioned above is represented by an inference rule using “now” (current time step) and “next” (next time step). The inference unit 191 can infer the state of each unit of the distillation system 920 in the next time step from the state of each unit of the distillation system 920 in the current time step by an inference using such an inference rule.

The time step updating unit 192 updates the time step, and the inference unit 191 further carries out an inference. As a result, the inference unit 191 can additionally infer the state of each unit of the distillation system 920 in the next time step. As a result of the update of the time step by the time step updating unit 192 and the inference by the inference unit 191 being repeated, the inference device 100 is capable of inferring the state of each unit of the distillation system 920 in each time step while successively updating the time step.

As described above, the inference unit 191 makes an inference in accordance with first-order predicate logic by using a true/false of a proposition that determines a state of a target by using a predicate that represents the state of the target, and an inference rule where a predicate representing a state of the target in an antecedent differs from a predicate representing a state of the target in a consequent. The predicate representing the state of the target in the antecedent and the predicate representing the state of the target in the consequent represent a proposition that determines the state of the target in different time steps.

As a result, the inference unit 191 can make a qualitative inference that handles temporal changes without the need to extend from first-order predicate logic. Therefore, the inference device 100 can make a qualitative inference that handles temporal changes. Further, in order for the inference device 100 to make a qualitative inference that handles temporal changes, a common qualitative inference method that handles first-order predicate logic can be used. In this respect, the burden of modifying the inference device 100 can be suppressed.

Moreover, the time step updating unit 192 uses the true/false of a proposition that determines, with respect to the same target, whether or not the state of the target in a certain time step is a certain state to overwrite the true/false of a proposition that determines whether or not the state of the target is that state in the previous time step. The inference unit 191 further makes a qualitative inference using the state information represented by the proposition after being overwritten by the time step updating unit 192.

As a result, the time step updating unit 192 is capable of updating the time step by relatively simple processing that uses the value of a proposition (true/false) to overwrite the value of another proposition. Then, the inference unit 191 can further make a qualitative inference that handles temporal changes after the time step update by the time step updating unit 192. Consequently, the update of the time step and the inference can be repeated by the inference device 100.

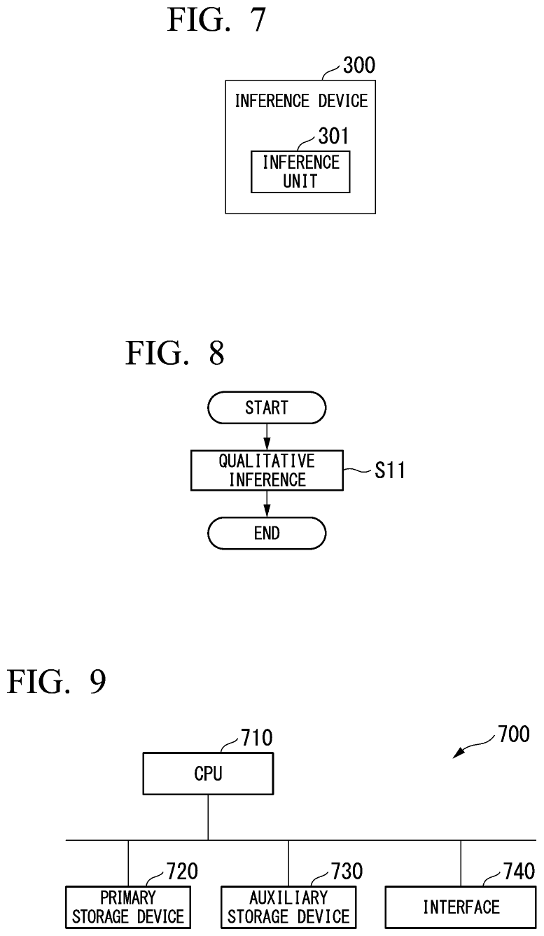

FIG. 7 is a diagram showing an example of a configuration of an inference device 300 according to the example embodiment. The inference device 300 shown in FIG. 7 includes an inference unit 301.

With this configuration, the inference unit 301 makes an inference in accordance with first-order predicate logic by using a true/false of a proposition that determines a state of a target by using a predicate that represents the state of the target, and an inference rule where a predicate representing a state of the target in an antecedent differs from a predicate representing a state of the target in a consequent. The predicate representing the state of the target in the antecedent and the predicate representing the state of the target in the consequent represent propositions that determine the state of the target in different time steps.

As a result, the inference unit 301 can make a qualitative inference that handles temporal changes without the need to extend from first-order predicate logic. Therefore, the inference device 300 can make a qualitative inference that handles temporal changes. Further, in order for the inference device 300 to make a qualitative inference that handles temporal changes, common qualitative inference methods that handle first-order predicate logic can be used. In this respect, the burden of modifying the inference device 300 can be suppressed.

FIG. 8 is a diagram showing an example of the processing procedure of an inference method according to the example embodiment.

The inference method shown in FIG. 8 includes a step for making a qualitative inference (step S11). In the step of making a qualitative inference (step S11), the inference unit makes an inference in accordance with first-order predicate logic by using a true/false of a proposition that determines a state of a target by using a predicate that represents the state of the target, and an inference rule where a predicate representing a state of the target in an antecedent differs from a predicate representing a state of the target in a consequent. The predicate representing the state of the target in the antecedent and the predicate representing the state of the target in the consequent represent propositions that determine the state of the target in different time steps.

As a result, in the inference method shown in FIG. 8, it is possible to make a qualitative inference that handles temporal changes without the need to extend from first-order predicate logic. Therefore, according to the inference method, a qualitative inference that handles temporal changes can be performed. Further, according to the inference method, in order to make a qualitative inference that handles temporal changes, common qualitative inference methods that handle first-order predicate logic can be used. In this respect, the burden of modifying the device that makes the qualitative inference can be suppressed.

FIG. 9 is a schematic block diagram showing a configuration of a computer according to at least one example embodiment.

In the configuration shown in FIG. 9, the computer 700 includes a CPU (Central Processing Unit) 710, a primary storage device 720, an auxiliary storage device 730, and an interface 740. Any one or more of the inference devices 10 and 300 described above may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Furthermore, the CPU 710 secures a storage area corresponding to each of the storage units in the main storage device 720 according to the program. The communication of each device with other devices is executed as a result of the interface 740 having a communication function and performing communication according to the control of the CPU 710. The auxiliary storage device 730 is a non-transitory recording medium such as a CD (Compact Disc) or a DVD (digital versatile disc).

When the inference device 100 is implemented by the computer 700, the operation of the control unit 190 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area corresponding to the storage unit 180 in the main storage device 720 according to the program. The communication performed by the communication unit 110 is executed as a result of the interface 740 having a communication function and performing communication according to the control of the CPU 710. The functions of the display unit 120 are executed as a result of the interface 740 having a display device, and images being displayed on the display screen of the display device according to the control of the CPU 710. The functions of the operation input unit 130 are performed as a result of the interface 740 having an input device and accepting user inputs, and outputting signals indicating the accepted user inputs to the CPU 710.

When the inference device 300 is implemented by the computer 700, the operation of the inference unit 301 is stored in the auxiliary storage device 730 in the form of a program. The CPU 710 reads the program from the auxiliary storage device 730, expands the program in the main storage device 720, and executes the processing described above according to the program.

Furthermore, a program for executing some or all of the processing performed by the control unit 190 and the processing performed by the inference unit 301 may be recorded in a computer-readable recording medium, and the processing of each unit may be performed by a computer system reading and executing the program recorded on the recording medium. The “computer system” referred to here is assumed to include an OS (Operating System) and hardware such as peripheral devices.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

The present invention has been described above with reference an example embodiment (and examples). However, the present invention is not limited to the example embodiment (and examples) above. Various changes to the configuration and details of the present invention that can be understood by those skilled in the art can be made within the scope of the present invention.

This application is based upon and claims the benefit of priority from Japanese patent application No. 2019-064978, filed Mar. 28, 2019, the disclosure of which is incorporated herein in its entirety by reference.

### INDUSTRIAL APPLICABILITY

The present invention may be applied to an inference device, an inference method, and a recording medium.

### REFERENCE SYMBOLS

100, 300 Inference device
110 Communication unit (communication means)
120 Display unit (display means)
130 Operation input unit (operation input means)
180 Storage unit (storage means)
190 Control unit (control means)
191, 301 Inference unit (inference means)
192 Time step updating unit (time step updating means)

1. An inference device comprising:
at least one memory configured to store instructions; and
at least one processor configured to execute the instructions to:
make an inference in accordance with first-order predicate logic by using: a true or false of a proposition that determines a state of a target by using a predicate that represents the state of the target; and an inference rule where a predicate representing a state of a target in an antecedent differs from a predicate representing a state of a target in a consequent,
wherein the predicate representing the state of the target in the antecedent and the predicate representing the state of the target in the consequent represent a proposition that determines a state of a target in a different time step.

2. The inference device according to claim 1, further comprising
wherein the at least one processor is configured to execute the instructions to use a true or false of a proposition that determines whether or not a state of a certain target is in a certain state in a certain time step, to overwrite a true or false of a proposition that determines whether or not the state of the certain target is the certain state at a time step before the certain time step, and
the at least one processor is configured to execute the instructions to further make a qualitative inference using state information represented by a proposition that has been overwritten by the time step updating means.

3. An inference method executed by a computer, comprising:
making an inference in accordance with first-order predicate logic by using: a true or false of a proposition that determines a state of a target by using a predicate that represents the state of the target; and an inference rule where a predicate representing a state of a target in an antecedent differs from a predicate representing a state of a target in a consequent,
wherein the predicate representing the state of the target in the antecedent and the predicate representing the state of the target in the consequent represent a proposition that determines a state of a target in a different time step.

4. A non-transitory recording medium that stores a program for causing a computer to execute:
making an inference in accordance with first-order predicate logic by using: a true or false of a proposition that determines a state of a target by using a predicate that represents the state of the target; and an inference rule where a predicate representing a state of a target in an antecedent differs from a predicate representing a state of a target in a consequent,
wherein the predicate representing the state of the target in the antecedent and the predicate representing the state of the target in the consequent represent a proposition that determines a state of a target in a different time step.
